(19) United States
(12) Patent Application Publication
(10) Pub. No.: US 2023/0252360 A1
(43) Pub. Date: Aug. 10, 2023

(54) EFFICIENT OPTIMIZATION OF MACHINE LEARNING MODELS

(71) Applicant: International Business Machines Corporation, Armonk, NY (US)

(72) Inventors: Song BO, Xian (CN); Dong Hai YU, Xian (CN); Jun WANG, Xian (CN); Yao Dong LIU, Xian (CN); Jiang Bo KANG, Xian (CN)

(21) Appl. No.: 17/650,440

(22) Filed: Feb. 9, 2022

(51) Int. Cl. G06N 20/20

(52) U.S. Cl. CPC G06N 20/20

(57) ABSTRACT

Techniques for optimizing machine learning models are provided. A first model in a first format is received. A second model is generated by applying one or more optimization techniques to the first model; the second model is an optimized version of the first model. The second model is converted into a common intermediate format. The second model is converted into binary data representing the second model. The binary data representing the second model is outputted.

### BACKGROUND

The present disclosure relates to optimized machine learning, and more specifically, to efficient techniques to optimize machine learning models.

Machine learning has been increasingly deployed to provide solutions for a wide variety of problem spaces. Along with the rise in machine learning, there is a constant desire for high prediction accuracy. To meet this demand, more advanced analysis techniques have been developed, including ensemble methods, deep neural networks, and more. However, ensembles are typically very large, often containing thousands of base models. Similarly, deep neural networks may contain many thousands of parameters, neurons, and layers.

Model size is incredibly important in various environments, as many communication paths (to transfer the model) and inferencing devices (which use trained models) are constrained in terms of computational resources and available bandwidth. Additionally, it is desirable that scoring performance, in terms of the processing time or resources needed to use the models, be improved. For example, in financial industries, machine learning may be used to determine the riskiness of a user's action, and it is generally desired that this evaluation be returned quickly (e.g., within 5 milliseconds). This time requirement requires significant execution efficiency.

Accordingly, there is a need for improved machine learning optimizations.

### SUMMARY

According to one embodiment of the present disclosure, a computer-implemented method is provided. The computer-implemented method includes receiving a first model in a first format; generating a second model by applying one or more optimization techniques to the first model, wherein the second model is an optimized version of the first model; converting the second model into a common intermediate format; converting the second model into binary data representing the second model; and outputting the binary data representing the second model.

According to one embodiment of the present disclosure, a system is provided. The system includes one or more computer processors; and a memory containing a program which when executed by the one or more computer processors performs an operation. The operation comprises receiving a first model in a first format; generating a second model by applying one or more optimization techniques to the first model, wherein the second model is an optimized version of the first model; converting the second model into a common intermediate format; converting the second model into binary data representing the second model; and outputting the binary data representing the second model.

According to one embodiment of the present disclosure, a computer product is provided. The computer product includes a computer-readable storage medium having computer-readable program code embodied therewith, the computer-readable program code executable by one or more computer processors to: receive a first model in a first format; generate a second model by applying one or more optimization techniques to the first model, wherein the second model is an optimized version of the first model; convert the second model into a common intermediate format; convert the second model into binary data representing the second model; and output the binary data representing the second model.

### BRIEF DESCRIPTION OF THE DRAWINGS

FIG. 1 depicts an example workflow for applying optimization techniques to generate an optimized machine learning model in binary format.

FIG. 2 depicts a flow diagram illustrating a method for applying optimization techniques to machine learning models.

FIG. 3 depicts a flow diagram illustrating a method for applying shared optimizations to machine learning models.

FIG. 4 is a flow diagram illustrating a method for applying cross-model optimizations to machine learning models.

FIG. 5 is an example workflow for instantiating an optimized model.

FIG. 6 is a flow diagram illustrating a method for applying optimization techniques to generate an optimized machine learning model.

FIG. 7 is a block diagram illustrating a computing device configured to use optimization techniques to optimize machine learning models.

### DETAILED DESCRIPTION

Embodiments of the present disclosure provide optimization techniques to generate optimized machine learning models, enabling improved inference latency.

Conventional techniques to improve inference latency generally only apply optimizations to the scoring process, but do not modify the model itself. Additionally, existing model formats have a variety of inefficiencies. As one example, predictive model markup language (PMML) is a popular standard in machine learning. However, PMML typically results in very large file sizes, resulting in inefficient models (in terms of size and scoring latency). Additionally, PMML does not represent all forms of data well. For example, PMML does not represent binary data well, which leads to myriad issues with images, audio, and video.

Although some other formats may be available, they are generally insufficient for various reasons. For example, one format, Extensible Markup Language/JavaScript Object Notation (XML/JSON), may store binary data but is generally inefficient in other ways for model performance. Another format, Open Neural Network Exchange (ONNX), may be more efficient for some cases, but can generally only be used for deep learning models. Conventional techniques are each associated with significant problems related to storage, scoring performance, and inference time.

In embodiments of the present disclosure, techniques are provided to optimize machine learning models to reduce models size and improve scoring performance (e.g., in terms of the latency or computational resources needed to generate an output inference using the optimized model). In some aspects, the optimized model can be efficiently marshalled to a binary format for improved storage and transmission. The model can similarly be unmarshalled to enable the model to be instantiated and used for efficient inferencing.

The optimization techniques described in the present disclosure can generally improve storage efficiency and scoring performance in machine learning models. For example, by intelligently reducing model size (e.g., by eliminating some parameters or consolidating ensembles), the techniques described herein enable machine learning models to be stored more efficiently (e.g., with reduced storage and memory needs) and transmitted more efficiently (e.g., using less data and reduced required bandwidth). Additionally, these optimized models can generally return output scores or inferences more efficiently (with reduced computational expense and time) due at least in part to the reduced sizes (along with other optimizations in some embodiments). In these ways, the optimization techniques described herein can significantly improve the functioning of the computer.

In some embodiments, multiple levels of optimizations can be applied to machine learning models: shared optimizations (which may be generally applicable across multiple model types), model-specific optimizations (which may each be applicable to specific types of models), and/or ensemble optimizations (which can be used to optimize model ensembles).

In some embodiments, the system can implement optimizations such as refraining from copying all elements of the model, instead only copying the important or relevant elements. For example, the system may remove elements that are unused for scoring (e.g., those which don't affect the model output), remove duplicate elements, remove unused elements, encode some values (such as strings) more efficiently, and the like. In some embodiments, ensemble optimizations may involve clustering the base models and dynamically constructing overarching models that can replace each cluster, thereby improving the overall ensemble. In at least one embodiment, the optimized model may then be converted to a common intermediate format (CIF). In some embodiments, converting to CIF can improve efficiency, as working with a model in CIF allows for complicated PMML standards (or standards from other formats) to be ignored. Additionally, in some aspects, CIF acts as an intermediary format between the input (e.g., PMML) and eventual output (e.g., binary) formats, which enables simple and efficient use of a wide variety of output formats (e.g., if a new binary format is desired). In an embodiment, the model (in the CIF) can then be converted to a binary format for efficient storage and/or transmission. By applying the optimizations and techniques described herein, storage efficiency and scoring efficiency can be significantly improved.

In some portions of the present disclosure, PMML is used as one example format for which the optimizations techniques can be applied. However, the optimization techniques of the present disclosure are readily applicable to a wide variety of languages and formats, and can be used to support various models including deep learning models, as well as supporting images, audio, and video data.

### Example Workflow for Generating an Optimized Machine Learning Model

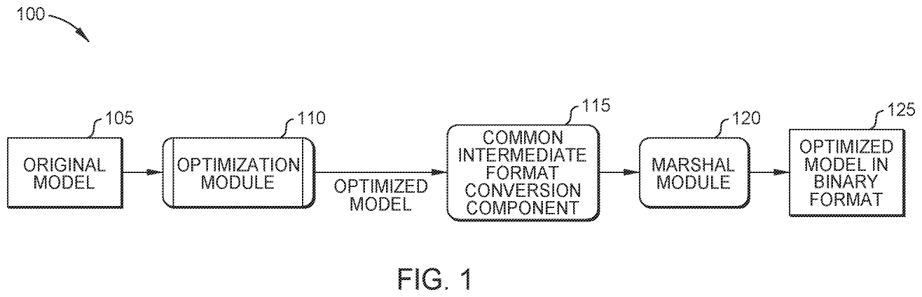

FIG. 1 depicts an example workflow 100 for applying optimization techniques to generate an optimized machine learning model in binary format.

In the illustrated workflow 100, an original model 105 is received by an optimization module 110. In embodiments, the original model 105 may be in any format. In some examples, the original model 105 can be a PMML model in the XML format. The original model 105 is generally representative of a machine learning model (which may be an ensemble model incorporating multiple base models), and may include any model architecture (such as a neural network, a decision tree, and the like). In embodiments, optimization module 110 can be implemented in a variety of ways, including as one or more hardware components, one or more software components executing on one or more devices, as a system operating in the cloud, and the like.

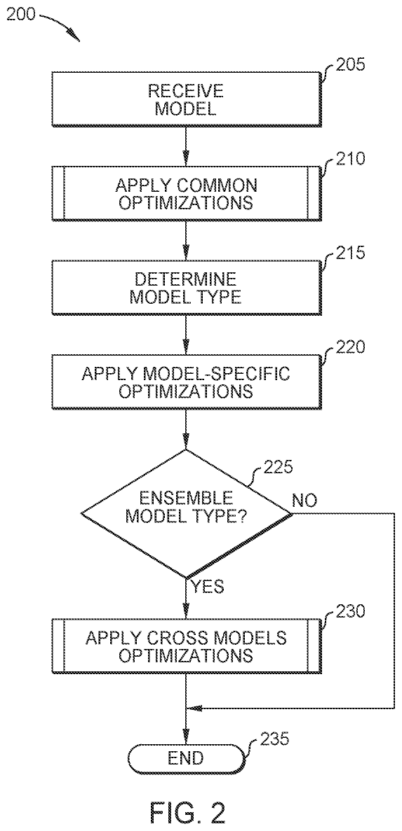

The optimization module 110 can generally apply one or more optimizations to the original model 105 to generate an optimized model. For example, as discussed in further detail below with reference to FIGS. 2-4, the optimization module 110 may remove unused or duplicate elements in the original model 105, consolidate base models in an ensemble, and the like.

In the illustrated example, after the optimization module 110 processes the original model 105, the resulting optimized model can be passed to a CIF conversion component 115. In one embodiment, this CIF conversion component 115 converts the optimized model into a CIF. Generally, CIF is a cross-language, cross-platform language that can be used to efficiently represent machine learning models. In one embodiment, the model can be represented in the CIF using two parts: metadata information and model content. In one embodiment, the metadata information can include data such as identifying input fields, derived fields, and output fields. The model content may differ based on the model type, but generally contain information relating to the different model structure data.

In some embodiments, the metadata information is stored using tabular data. In one such embodiment, use of tabular storage enables the optimizations to be readily represented, stored, and transmitted for efficient computation and storage. Additionally, in some embodiments, tabular storage can save storage by enabling use of continuous memory for numeric values. Further, in some aspects, the tabular storage enables efficient parallel computing on the data in the columns and rows. One example of tabular metadata is given below, in Table 1.

TABLE 1

| Name | datatype | optype | role |
|---|---|---|---|
| f1 | double | continuous | input |
| f2 | double | continuous | input |
| . . . | . . . | | . . . |
| fn | string | categorical | target |

In the example Table 1, each row corresponds to a field involving model prediction computation. The first column corresponds to the name of the field, while the second column indicates to the data type used by the field. In various embodiments, the data type can be one of an integer, double, string, date, etc. The third column corresponds to the operation type, such as continuous, categorical, ordinal, and the like. In an embodiment, these operation types indicate which operations are supported. The last illustrated column corresponds to the role of the field. In various embodiments, the role of the field may include input, target, output, and the like.

In the illustrated workflow 100, the optimized model (in the CIF) is then passed to the marshal module 120. The marshal module 120 can generally convert the model into a defined or specified binary format. In an embodiment, the particular binary format may be selected by a user or administrator.

The final output of the workflow 100 is an optimized model in binary format 125. Generally, as discussed above, this optimized model in binary format 125 may be in any desired binary format. Generation of the optimized model in binary format 125 can generally result in a wide variety of improvements. For example, the optimized model in binary format 125 can enable improved and more efficient storage and transmission, as it will generally be smaller than the original model 105 and has been translated (e.g., using the CIF conversion component 115 and the marshal module 120) for more optimized storage and transmission. Additionally, as discussed above, the optimized model in binary format 125 results in improved scoring performance and inference time. That is, the optimized model in binary format 125 can be used to perform inferencing (e.g., generating outputs based on input data during runtime) more efficiently and quickly than the original model 105.

### Example Flow Diagram Illustrating a Method for Applying Optimization Techniques to Machine Learning Models

FIG. 2 depicts a flow diagram illustrating a method 200 for applying optimization techniques to machine learning models.

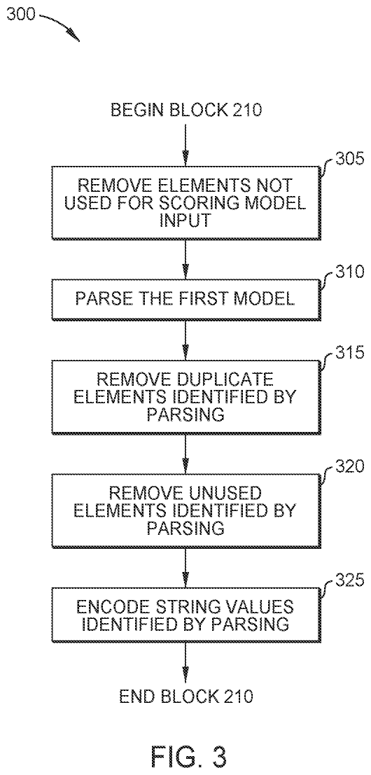

In one embodiment, the illustrated method 200 may be performed by an optimization module, such as optimization module 110 of FIG. 1. At block 205, an original model (e.g., the original model 105 of FIG. 1) is received. At block 210, shared optimization techniques are applied to the original model. As discussed above, shared optimization techniques may generally include optimizations that are applicable to multiple model types. Some examples of such shared optimizations are described in greater detail below with reference to FIG. 3.

At block 215, the type of the received model is determined. In some embodiments, determining the model type includes identifying the architecture of the model and/or the format used to represent the model (which can be used to identify which other optimization techniques can be applied). For example, some optimizations may be applicable to neural networks, while others are uniquely applicable to decision trees.

At block 220, the optimization module can identify and apply any applicable model-specific optimizations for the model, based on the determined model type. As one example, suppose the original model is a tree-type model (e.g., a decision tree or regression tree). In an embodiment, this tree model may have specific optimization techniques applied, resulting in cleaner and neater tree structures. For example, reverse traversal can be used on the tree from the leaf nodes. Using this technique, full paths (from the root to the leaf) can be determined, which allows for efficient identification of any duplicate or useless nodes. In some embodiments, one model-specific technique may include pruning useless nodes from the tree. For example, useless nodes may be found when traversing the tree in order to determine whether each node is actually used (e.g., is reachable in the tree). When such useless nodes are found, the useless node can be removed from the tree. In some embodiments, the specific techniques can include removal or combination of duplicated nodes. For example, duplicate nodes may be found by traversing the tree and determining whether each node is present more than once. In such a case, the optimization module may identify the duplicates and remove them.

As another example, the model may be an XGBoost model. This XGBoost model may similarly have specific optimization techniques applied. For example, in some aspects, the model have be represented using data elements including one or more of a predicate, an operator, a value, a score, and the like. In some aspects, applying the model specific optimization can include determining whether a node or element score is equal to zero. In one such embodiment, if a node score is equal to zero, it may be eliminated or removed from the model.

As another example, in some embodiments the model may be a regression model, which may similarly have specific applicable optimization techniques. In some aspects, regression models may generally include a set of nodes, where each node has various fields including a coefficient (also referred to in some embodiments as a weight). In one such embodiment, a model-specific optimization may include removing predictors or nodes with a coefficient equal to zero.

In the illustrated example, the method then continues to block 225, where the optimization module determines whether the received original model is an ensemble model. If not, the method 200 terminates at block 235.

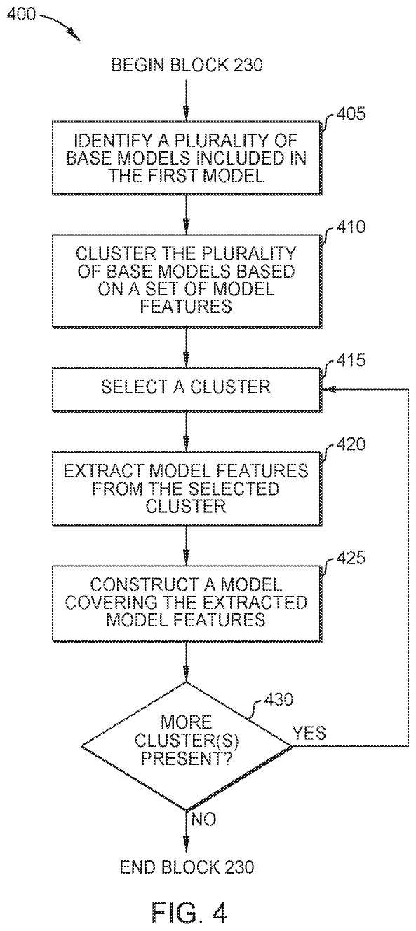

If the model is an ensemble model, the method proceeds to block 230. At block 230, cross-model optimization techniques can be applied. For example, in some embodiments, cross-model optimizations can include constructing new models to replace a subset of base models based on extracted features. Some example cross-model optimization techniques are described in further detail below with reference to FIG. 4. After the cross-model optimization techniques of block 230 are applied, the method proceeds to block 235, where the method ends.

### Example Flow Diagram Illustrating a Method for Applying Common Optimizations

FIG. 3 depicts a flow diagram illustrating a method 300 for applying common optimizations. In one embodiment, the method 300 is performed by an optimization module, such as optimization module 110 of FIG. 1.

In one embodiment, the illustrated method 300 provides additional detail for block 210, discussed above with reference to FIG. 2. The method 300 can generally be used to apply common or shared optimizations to the received model(s). These common optimizations may generally apply multiple model types.

The method 300 begins at block 305. At block 305, the optimization module can identify elements that are not used for scoring the model input, and remove these elements. That is, only the elements that are required or actually used for scoring input are kept, and non-scoring elements may be deleted, discarded, or otherwise removed. For example, in some embodiments, non-scoring informational elements such as those corresponding to or providing detail about model statistics, model explanations, model verifications, and the like can be removed, as they are generally included to provide human-readable information but do not affect the actual output of the model.

At block 310, the model is parsed to identify any duplicate elements, unused elements, and/or string values in the model. In one embodiment, duplicate or redundant elements can be detected by identifying redundant input fields (e.g., multiple input fields that receive the same input feature(s), or that correspond to the same input data). Similarly, the system may identify redundant derived fields (e.g., multiple nodes that are derived, using the same input data). In some embodiments, unused elements are detected by traversing the model to determine whether each elements is actually used for scoring. For example, a node may be derived based on input and/or upstream nodes, but the output of the node may be unused (in that it doesn't actually affect the final scoring). In some embodiments, parsing the model can include identifying string values.

At block 315, any identified duplicate or redundant elements are removed from the model. That is, these elements or nodes can be deleted, discarded, or otherwise removed from the model. If there were no duplicate elements that were identified, the method 300 may continue to block 320.

At block 320, the identified unused elements are removed from the model. As above, if there were no unused elements that were identified, the method 300 proceeds to block 325.

At block 325, the identified string values are encoded. If there were no string values that were identified, the method 300 terminates. In an embodiment, the string encoding can reduce storage requirements, as well as introducing faster and more efficient comparison. For example, suppose there are three string values: “longstring1,” “longstring2,” and “longstring3.” In an embodiment, a map can be created to represent these values (e.g., numerically). For example, a value of 0 may be used to represent “longstring1,” a value of 1 may be used to represent “longstring2,” and a value of 2 may be used to represent “longstring3.” These encoded values (e.g., 0, 1, and 2) can then be used to represent the string values in memory. During computation, the values can be compared efficiently, rather than comparing the actual strings.

### Example Flow Diagram Illustrating a Method for Applying Cross-Model Optimizations

FIG. 4 is a flow diagram illustrating a method 400 for applying cross-model optimizations.

In one embodiment, the illustrated method 400 may be performed by an optimization module, such as the optimization module 115 of FIG. 1. In some embodiments, the method 400 provides additional detail for block 230, discussed above with reference to FIG. 2, where cross-model optimizations can be applied to the received model. In some embodiments, these cross-model optimizations are applied to ensemble models. For explanatory purposes, the tree model will be used. However, this is only one example and should not be construed as limiting.

The method begins at block 405, where a plurality of base models that are included in the first model are identified. As discussed above, ensemble models are generally constructed using multiple underlying base models. For example, output from some base models may be used as input to other base models, input data may be processed using one or more base models in order to select the base model(s) that should be used to classify or otherwise generate an output based on the data, and the like.

At block 410, the set of base models are clustered based on a set of model features. In embodiments, the particular features used may differ based at least in part on the base model types. Using a tree model as an example, the features may include the total number of nodes, the number of child nodes, the depth of the tree, the number of used split fields, and the like. Generally, the models may be clustered using any suitable clustering technique. As a result, each cluster can generally include one or more base models that have the same (or sufficiently similar) features. The method then proceeds to block 415, where one cluster is selected.

At block 420, the features are extracted from the selected cluster. That is, the optimization module can identify and extract the shared features of the base models within the cluster. At block 425, a model is constructed that covers the model features that were extracted at block 420. For example, models in the same cluster may be treated as having similar structure. A complete structure that can cover all of the models can therefore be extracted. In some embodiments, parameters from the models in each cluster are then extracted, and one model can then be constructed using these extracted parameters.

At block 430, it is determined whether there is at least one additional cluster present that has not yet been evaluated. If not, the method 400 terminates. If there is at least one more cluster present, the method 400 returns back to block 415. In this way, the optimization module can effectively represent the ensemble model using a relatively smaller set of base models.

### Example Workflow for Outputting an Optimized Model

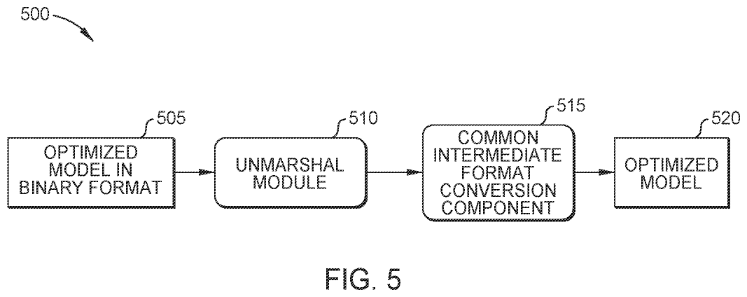

FIG. 5 is an example workflow 500 for outputting an optimized model.

In the illustrated workflow 500, an optimized model in binary format 505 is received by an unmarshal module 510. In some embodiments, the optimized model in binary format 505 may correspond to the optimized model in binary format 125, discussed above with reference to FIG. 1. For example, a first system may use the workflow 100 to generate the optimized model. The model may then be stored for future use, transmitted to a second system, and the like. The workflow 500 generally provides detail for instantiating and deploying this optimized model.

The unmarshal module 510 can generally receive the binary input (e.g., as a stream of binary bits) and unmarshal it to translate it into the CIF, as discussed above. After the unmarshal module 510 is applied to the optimized model in binary format 505 to yield a model in the CIF format, the model can be passed to a CIF conversion component 515. This CIF conversion component 515 converts the optimized model in CIF into a final output format that can be used to instantiate or deploy the optimized model. As discussed above, use of the CIF can improve computational efficiency by simplifying or reducing the relevant or applicable standards, as well as enabling a wide variety of output formats to be efficiently integrated into the system.

As illustrated in the workflow 500, the CIF conversion component 515 outputs an optimized model 520. This optimized model 520 may generally be in a format that is readily instantiable or deployable (e.g., in PMML and/or XML). In this way, the workflow 500 enables the optimized model in binary format 505 to be translated back to a machine-usable format. Although not depicted in the illustrated example for conceptual clarity, in embodiments, the system may then deploy this optimized model 520 for runtime inferencing. As discussed above, the optimized model 520 can generally enable enhanced and improved scoring performance, such as through reduced memory and storage usage, reduced inference latency, and the like.

### Example Flow Diagram Illustrating a Method to Generate an Optimized Machine Learning Model

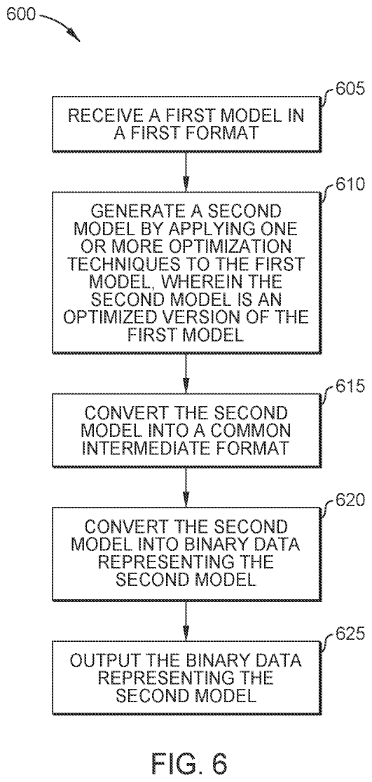

FIG. 6 is a flow diagram illustrating a method 600 for generating an optimized machine learning model.

At block 605, the optimization module receives a first model in a first format.

At block 610, the optimization module generates a second model by applying one or more optimization techniques to the first model, wherein the second model is an optimized version of the first model.

At block 615, the optimization module converts the second model into a common intermediate format.

At block 620, the optimization module converts the second model into binary data representing the second model.

At block 625, the optimization module outputs the binary data representing the second model.

In some aspects, the optimization techniques comprise at least one of: common optimization techniques, wherein the common optimization techniques apply to multiple model types; model-specific optimization techniques, wherein each of the model-specific optimization techniques applies to a particular model type; or cross-model optimization techniques, wherein the cross-model optimization techniques apply to ensemble model types.

In some aspects, the common optimization techniques comprise: removing elements not used for scoring model input; removing redundant elements; removing unused elements; and encoding string values.

In some aspects, removing redundant elements comprises: parsing the first model; determining, based on the parsing, that a first element corresponds to a first input value; and upon determining, based on the parsing, that a second element also corresponds to the first input value, removing either the first element or the second element from the first model.

In some aspects, a first model specific optimization applies to trees, and comprises at least one of: pruning useless nodes; or combining duplicated nodes.

In some aspects, a third model specific optimization applies to regression models, and comprises removing nodes with a coefficient of zero.

In some aspects, cross-model optimization techniques comprise: identifying a plurality of base models included in the first model; clustering the plurality of base models based on a set of model features; and for each respective cluster, extracting a model structure that matches output of each base model in the respective cluster.

In some aspects, the second model in the common intermediate format comprises metadata information and model content, and all information of the second model in the common intermediate format is stored by tabular data.

In some aspects, the method 600 further includes outputting the binary data representing the second model comprises transmitting the binary data to a remote system; and the remote system instantiates an optimized version of the first model by: converting the binary data to a third model in the common intermediate format; converting the third model to a fourth model in the first format; and instantiating the optimized version of the first model based on the fourth model in the first format.

### Example Block Diagram Illustrating a Computing Device Configured to Use Optimization Techniques to Optimize Machine Learning Models

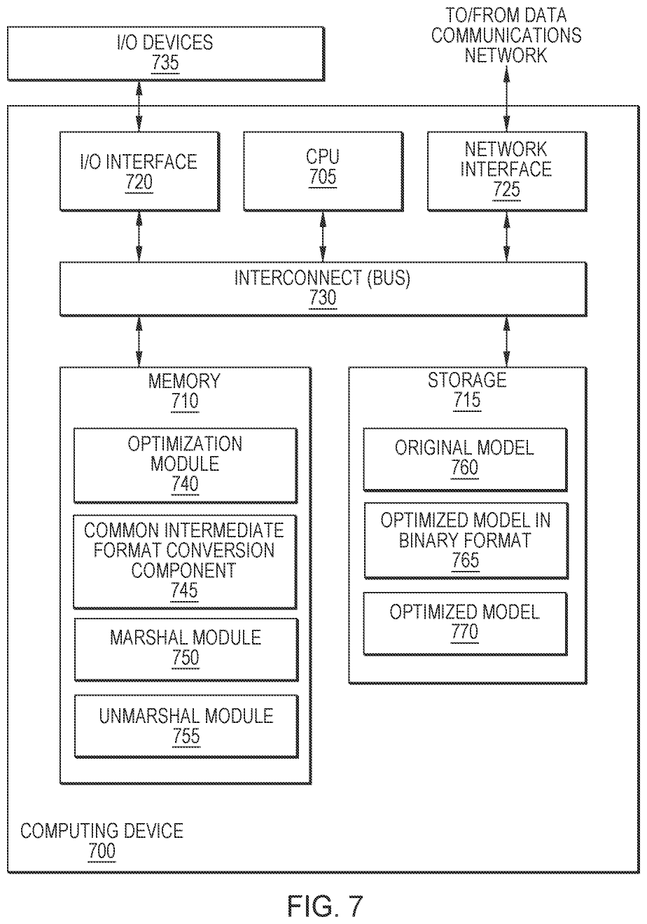

FIG. 7 is a block diagram illustrating a computing device 700 configured to use optimization techniques to optimize machine learning models.

As illustrated, the computing device 700 includes a CPU 705, memory 710, storage 715, a network interface 725, and one or more I/O interfaces 720. In the illustrated embodiment, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally included to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

In the illustrated embodiment, the memory 710 includes an optimization module 740, CIF conversion component 745, marshal module 750, and unmarshal module 755, which may perform one or more embodiments discussed above. For example, optimization module 740 may be configured to apply model optimization techniques, as discussed above. In at least one embodiment, the optimization module 740 corresponds to optimization module 110 of FIG. 1.

The CIF conversion component 745 can generally be used to convert a model into CIF, as discussed above, and/or to convert a model from CIF to a deployable/instantiable format. In at least one embodiment, the CIF conversion component 745 corresponds to the CIF conversion component 115 of FIG. 1 and/or CIF conversion component 515 of FIG. 5. The marshal module 750 may generally be used convert the model into binary format (e.g., a stream of binary bits), as discussed above. In at least one embodiment, the marshal module 750 corresponds to the marshal module 120 of FIG. 1. The unmarshal module 755 may generally be used to convert the model from binary (e.g., from a binary stream of bits) into another format, such as CIF, as discussed above. In at least one embodiment, the unmarshal module 755 corresponds to the unmarshal module 510 of FIG. 5.

Although depicted as discrete components for conceptual clarity, in embodiments, the operations of the depicted components (and others not illustrated) may be combined or distributed across any number of components. Further, although depicted as software residing in memory 710, in embodiments, the operations of the depicted components (and others not illustrated) may be implemented using hardware, software, or a combination of hardware and software.

Additionally, though depicted as residing on a single computing device 700, in some embodiments, the components may be distributed across multiple devices. For example, the optimization module 740, CIF conversion component 745, and marshal module 750 may be included in a first device (e.g., a device which trains or otherwise prepares models for transmission or storage). The unmarshal module 755 (and, in some aspects, the CIF conversion component 745) may be included in a second device (e.g., a device which receives and uses trained models).

In the illustrated example, the storage 715 includes an original model 760, an optimized model in binary format 765, and an optimized model 770, each discussed above. In an embodiment, the original model 760 may correspond to the original model 105 in FIG. 1. In an embodiment, the optimized model in binary format 765 corresponds to the optimized model in binary format 125 in FIG. 1 and/or the optimized model in binary format 505 in FIG. 5. In an embodiment, the optimized model 770 corresponds to the optimized model 520 in FIG. 5.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A computer-implemented method, comprising:
receiving a first model in a first format;
generating a second model by applying one or more optimization techniques to the first model, wherein the second model is an optimized version of the first model;
converting the second model into a common intermediate format;
converting the second model into binary data representing the second model; and
outputting the binary data representing the second model.

2. The computer-implemented method of claim 1, wherein the optimization techniques comprise at least one of:
common optimization techniques, wherein the common optimization techniques apply to multiple model types;
model-specific optimization techniques, wherein each of the model-specific optimization techniques applies to a particular model type; or
cross-model optimization techniques, wherein the cross-model optimization techniques apply to ensemble model types.

3. The computer-implemented method of claim 2, wherein the common optimization techniques comprise:
removing elements not used for scoring model input;
removing redundant elements;
removing unused elements; and
encoding string values.

4. The computer-implemented method of claim 3, wherein removing redundant elements comprises:
parsing the first model;
determining, based on the parsing, that a first element corresponds to a first input value; and
upon determining, based on the parsing, that a second element also corresponds to the first input value, removing either the first element or the second element from the first model.

5. The computer-implemented method of claim 2, wherein a first model specific optimization applies to trees, and comprises at least one of:
pruning useless nodes; or
combining duplicated nodes.

6. The computer-implemented method of claim 2, wherein a third model specific optimization applies to regression models, and comprises removing nodes with a coefficient of zero.

7. The computer-implemented method of claim 2, wherein the cross-model optimization techniques comprise:
identifying a plurality of base models included in the first model;
clustering the plurality of base models based on a set of model features; and
for each respective cluster, extracting a model structure that matches output of each base model in the respective cluster.

8. The computer-implemented method of claim 1, wherein the second model in the common intermediate format comprises metadata information and model content, and wherein all information of the second model in the common intermediate format is stored by tabular data.

9. The computer-implemented method of claim 1, wherein:
outputting the binary data representing the second model comprises transmitting the binary data to a remote system; and
the remote system instantiates an optimized version of the first model by:
converting the binary data to a third model in the common intermediate format;
converting the third model to a fourth model in the first format; and
instantiating the optimized version of the first model based on the fourth model in the first format.

10. A system, comprising:
one or more computer processors; and
a memory containing a program which when executed by the one or more computer processors performs an operation, the operation comprising:
receiving a first model in a first format;
generating a second model by applying one or more optimization techniques to the first model, wherein the second model is an optimized version of the first model;
converting the second model into a common intermediate format;
converting the second model into binary data representing the second model; and
outputting the binary data representing the second model.

11. The system of claim 10, wherein the optimization techniques comprise at least one of:
common optimization techniques, wherein the common optimization techniques apply to multiple model types;
model-specific optimization techniques, wherein each of the model-specific optimization techniques applies to a particular model type; or
cross-model optimization techniques, wherein the cross-model optimization techniques apply to ensemble model types.

12. The system of claim 11, wherein the common optimization techniques comprise:
removing elements not used for scoring model input;
removing redundant elements;
removing unused elements; and
encoding string values.

13. The system of claim 11, wherein the cross-model optimization techniques comprise:
identifying a plurality of base models included in the first model;
clustering the plurality of base models based on a set of model features; and
for each respective cluster, extracting a model structure that matches output of each base model in the respective cluster.

14. The system of claim 10, wherein the second model in the common intermediate format comprises metadata information and model content, and wherein all information of the second model in the common intermediate format is stored by tabular data.

15. The system of claim 10, wherein:
outputting the binary data representing the second model comprises transmitting the binary data to a remote system; and
the remote system instantiates an optimized version of the first model by:
converting the binary data to a third model in the common intermediate format;
converting the third model to a fourth model in the first format; and
instantiating the optimized version of the first model based on the fourth model in the first format.

16. A computer program product comprising:
a computer-readable storage medium having computer-readable program code embodied therewith, the computer-readable program code executable by one or more computer processors to:
receive a first model in a first format;
generate a second model by applying one or more optimization techniques to the first model, wherein the second model is an optimized version of the first model;
convert the second model into a common intermediate format;
convert the second model into binary data representing the second model; and
output the binary data representing the second model.

17. The computer program product of claim 16, wherein the optimization techniques comprise at least one of:
common optimization techniques, wherein the common optimization techniques apply to multiple model types;
model-specific optimization techniques, wherein each of the model-specific optimization techniques applies to a particular model type; or
cross-model optimization techniques, wherein the cross-model optimization techniques apply to ensemble model types.

18. The computer program product of claim 17, wherein the common optimization techniques comprise:
removing elements not used for scoring model input;
removing redundant elements;
removing unused elements; and
encoding string values.

19. The computer program product of claim 17, wherein the cross-model optimization techniques comprise:
identifying a plurality of base models included in the first model;
clustering the plurality of base models based on a set of model features; and
for each respective cluster, extracting a model structure that matches output of each base model in the respective cluster.

20. The computer program product of claim 16, wherein the second model in the common intermediate format comprises metadata information and model content, and wherein all information of the second model in the common intermediate format is stored by tabular data.
